(19) United States
(12) Patent Application Publication
(10) Pub. No.: US 2011/0056949 A1
(43) Pub. Date: Mar. 10, 2011

(54) PACKAGE CONSISTING OF A CONTAINER AND A LID

(75) Inventors: Franz Reiterer, Getzersdorf (AT); Lambert Nekula, Hofstetten (AT); Martin Kornfeld, Klosterneuburg (AT); Peter Stiebock, St.Polten (AT)

(73) Assignee: Teich Aktiengesellschaft, Weinburg (AT)

(21) Appl. No.: 12/867,062

(22) PCT Filed: Jan. 29, 2009
(86) PCT No.: PCT/AT2009/000029

§ 371 Date: Oct. 28, 2010

(30) Foreign Application Priority Data
Feb. 18, 2008 (AT) A 261/2008

(51) Int. Cl. B65D 53/00; B29C 51/02

(52) U.S. Cl. 220/361; 264/153

(57) ABSTRACT

A package includes a container and a lid, the lid being attached to the container edge by a sealing layer. The container wall, at least in the region of the container edge, has a depression formed toward the container interior.

The invention relates to a package consisting of a container and a lid, the lid being attached to the container edge by way of a sealing layer.

Packages of the initially mentioned type are known and are used, for example, for foods. For this purpose, the containers are filled with foods and then sealed with the lid.

The lid material on the side facing the container has a sealing layer via which the lids are attached to the container edge using sealing tools. The foods are protected against the penetration of air, moisture and impurities by this closure.

The package is user-friendly since it can be opened without additional aids. This takes place by using a so-called tear-off force that is necessary in order to be able to peel the lid off the container.

When the containers are filled with food, a priority objective in the selection of materials is that they satisfy the regulations of the Food Law. For milk products, especially suitable container materials are polystyrene, polypropylene and polyethylene terephthalate. Lid materials are preferably aluminum foils or film composites, containing polymers, paper or aluminum.

Higher and higher demands are imposed on the aforementioned materials so that the object of this invention is now to make available a packaging design with reduced material consumption that at the same time meets legal requirements and satisfies customer demands.

According to the invention, a package of the initially mentioned type is suggested that is characterized in that the container wall at least in the region of the container edge has a depression formed toward the container interior. Advantageous configurations of the package according to the invention are disclosed according to the dependent claims.

The invention relates furthermore to a method for producing a lid for the packaging according to the invention, in a continuous method by means of printed marks the lid form being applied on the lid material and the lid then being punched out according to this printing block.

The invention furthermore relates to a method for producing a container for the package according to the invention, the container shape and the depression in the container wall being formed by means of thermoforming using die and matrix tools.

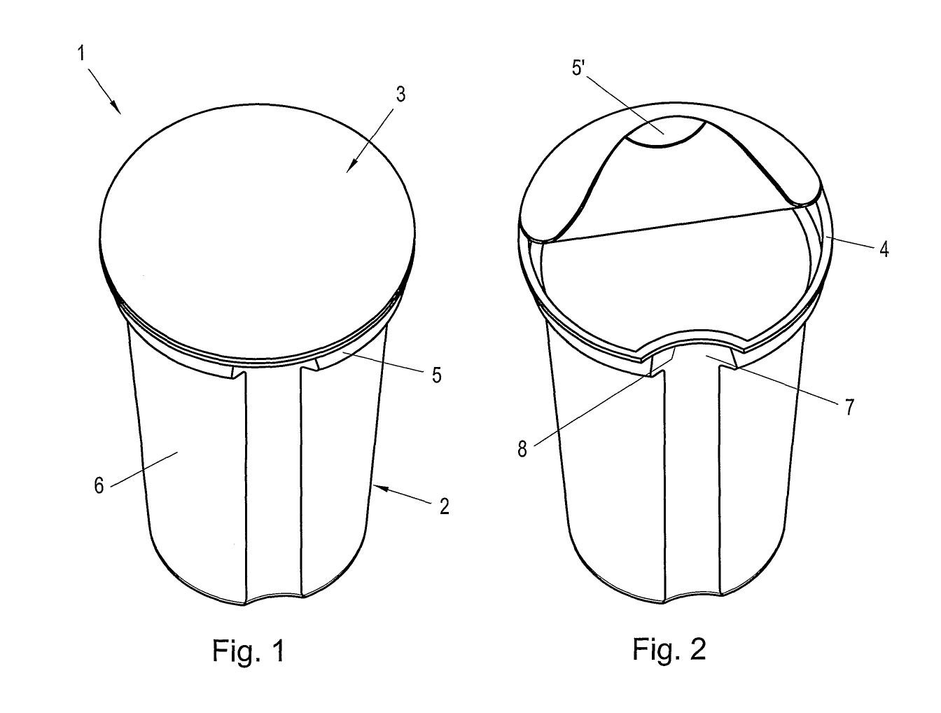

The invention is explained in more detail below using possible embodiments of the invention and using exemplary representations according to FIGS. 1 to 12.

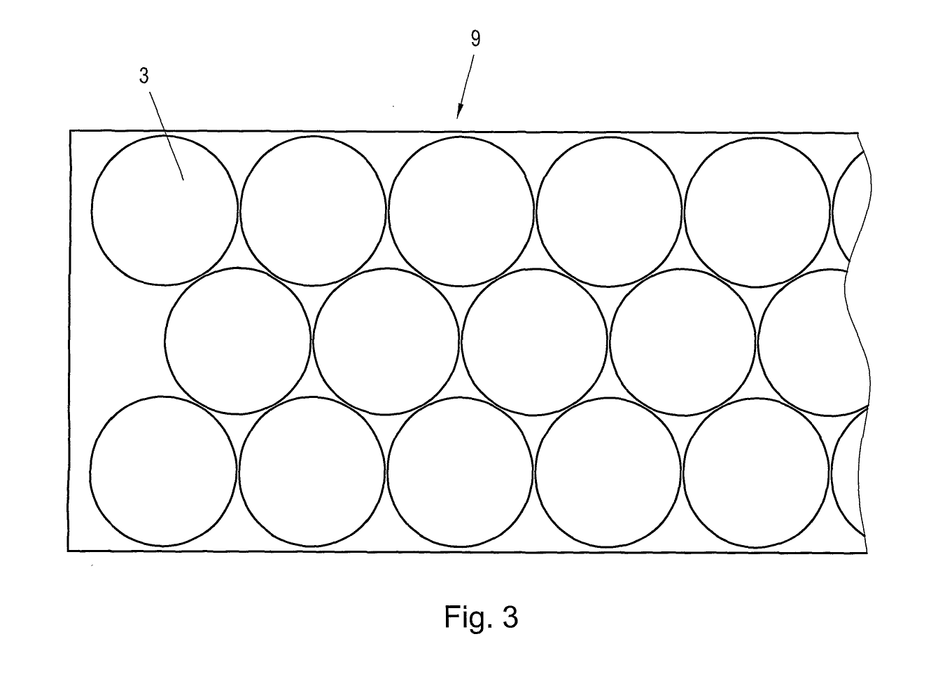

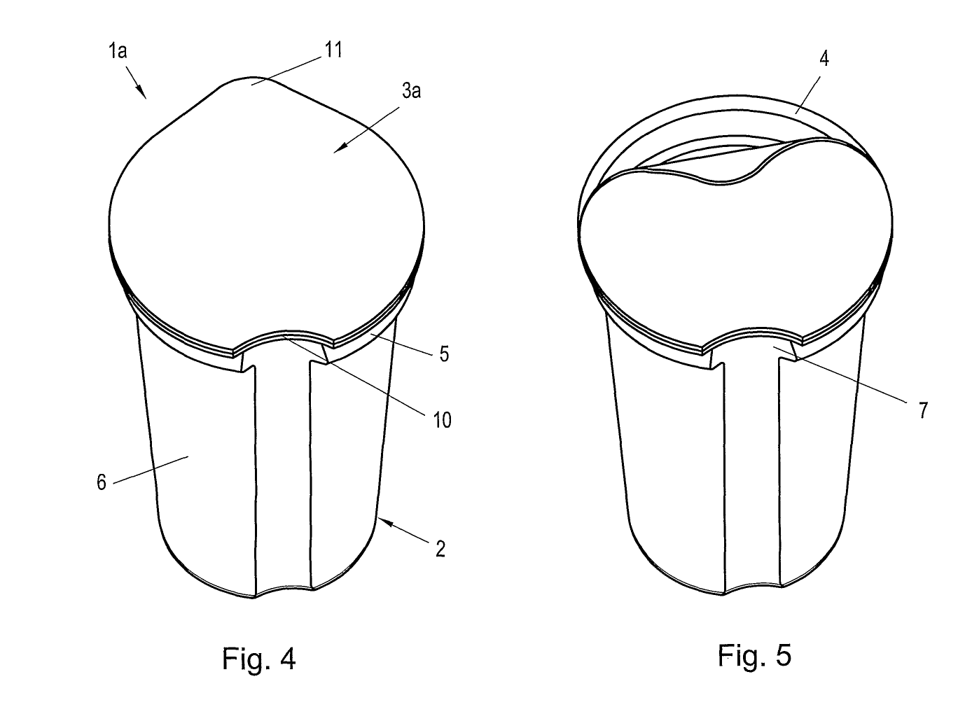

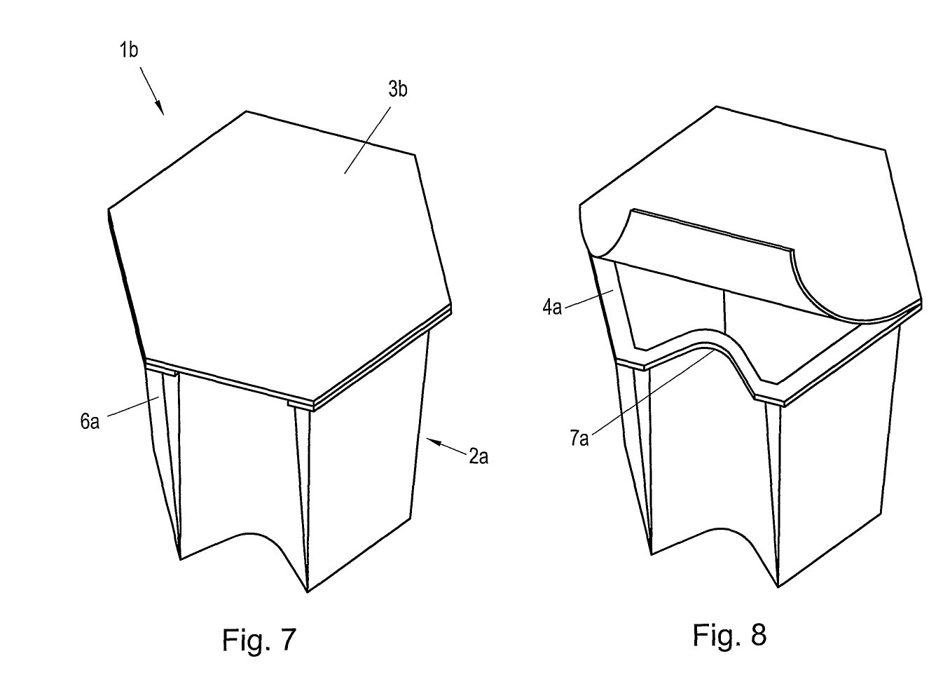

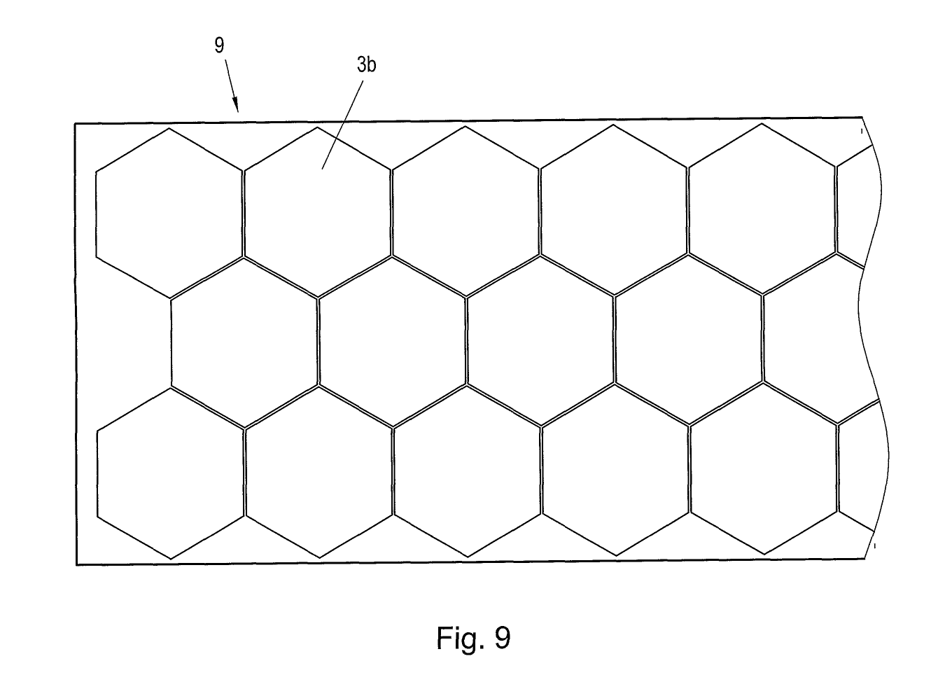

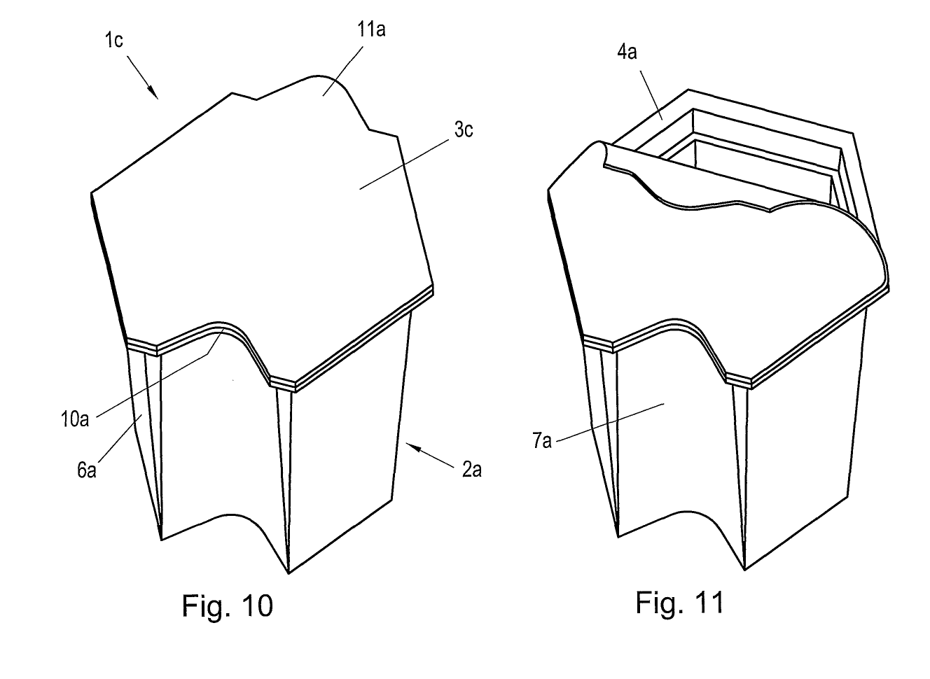

Here, FIGS. 1 and 2 show a package 1 with a container 2 that has a depression 7 in the form of a circular segment. FIG. 3 shows a film or foil material 9 for producing the lid 3. FIGS. 4, 5 and 6 show a special configuration of the lid 3a with a recess 10 and a gripping lug 11. FIGS. 7 and 8 show a container 2a that has a V-shaped depression 7a and is closed with a hexagonal lid 3b that can be produced from a material as shown in FIG. 9. FIGS. 10, 11 and 12 furthermore show a polygonal lid 3c that has a recess 10a and a gripping lug 11a.

The parent material for producing the lid will be used as efficiently as possible by the production of the package according to the invention. This is necessary in that the resources for aluminum are limited and the material combinations sometimes desired by customers are complex in their structure such that saving of parent material is also necessary for these reasons.

Thus, as shown in FIG. 3, the dimensions of the lid 3 are attached on the packaging material film or foil 9 by means of printed marks. The packaging material film or foil can consist of, for example, aluminum or a multilayer composite of a sealable polypropylene layer and polyethylene layers joined to it. Since this embodiment of the lid 3 does not provide for a gripping lug, almost no material scrap need be expected when the lid is being punched out. When the package 1 is opened—see FIGS. 1 and 2—simplified handling for the consumer will still be ensured so that the container 2 at least in its edge region 5 has a depression 7 of a type such that in the region of the depression by means of thumb pressure, the lid 3 can be withdrawn from the container edge 4. In order to facilitate this process, sometimes in the container edge there can be a scored site 8, which for the consumer facilitates gripping of the lid 3 when the opening process is being initiated, in the course of applying force a partial region 5′ being ripped out of the container edge 8.

The containers 2 are produced, for example, such that a polystyrene film is supplied to a heating unit so that the polystyrene is converted into a soft elastic state. Then, the soft elastic film is worked by means of thermoforming using die and matrix tools. These tools are configured such that, on the one hand, the depression 7 in the container edge 8 and the container edge 6 can be formed according to FIGS. 1 and 2.

The containers 2 can be stored at this point or filled directly after their production and can be sealed with the corresponding sealing tools using the punched-out lid 3. If it should be desirable to provide an opening aid in the form of a gripping lug, this is explained in more detail using FIGS. 4, 5 and 6.

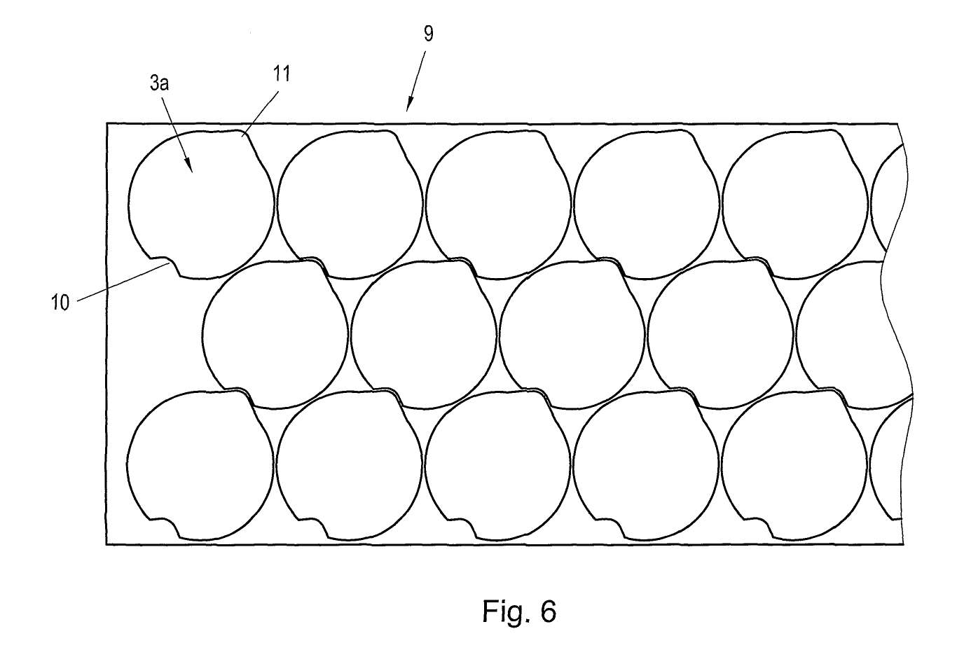

FIG. 6 shows a material-saving method for producing the lid 3a. Here, printed marks are placed on the packaging material film or foil 9 such that one gripping lug 11 at a time engages the recess 10 of the adjacent lid. Thus, a plurality of lids 3a can be punched out, but without parent material being unnecessarily wasted. Since conventionally the lid must also be matched to the container in its dimension, the aforementioned thermoforming method that has already been described is suitable for this purpose, since at this point the recess 10 in the lid 3a matches the depression 7 in the container edge region 5, fitting exactly. The gripping lug 11 itself projects over the container edge 4; this, however, does not influence the overall appearance of the package 1a, since consumers are accustomed to opening aids such as gripping lugs 11.

It is often desirable to be deliberately distinguished from competitive products by the shape of the package. This packaging design can be easily and economically implemented using this invention, as is explained using FIGS. 7 to 9.

Thus, as shown in FIG. 9, a film or foil material 9 is used on which the hexagonal shape of the lid 3b is applied using printed marks. The printed marks are positioned such that the lids 3b are arranged in the manner of a honeycomb so that film or foil scrap can be expected only in the edge region of the film or foil 9. Also, with respect to hexagonal lids that must be matched to the respective container shape 1b, the thermoforming method can be used with the difference that here a U-shaped depression 7a is advantageous since the opening process, i.e., the peeling of the lid 3b off the edge 4a, can easily take place by means of thumb pressure.

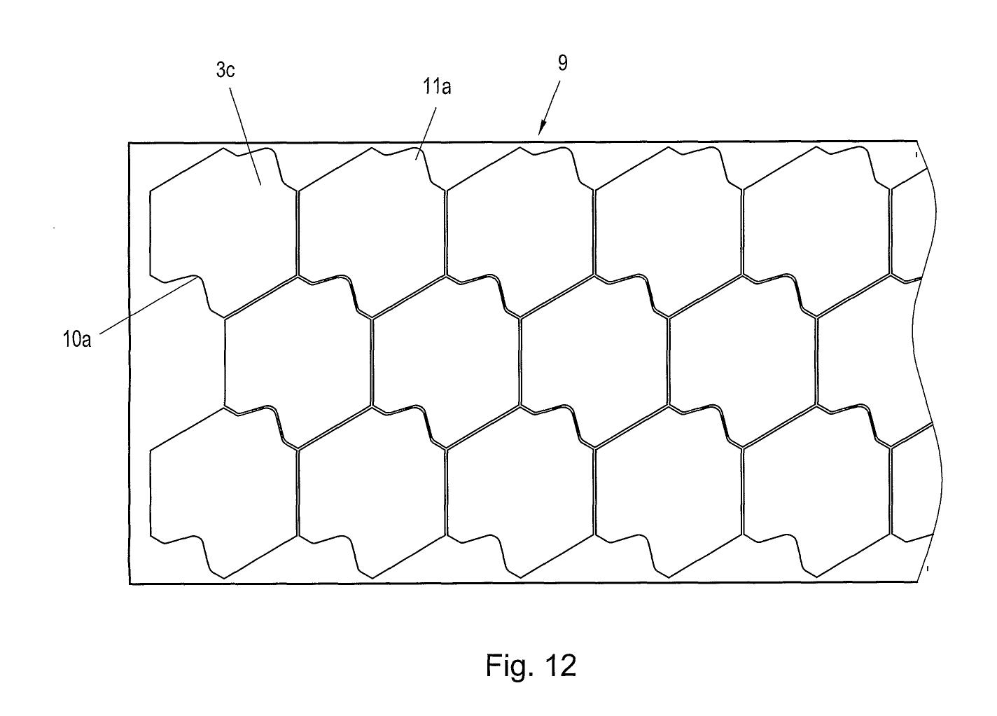

One especially imaginative configuration of the lid 3c is explained using FIGS. 10 to 12. As is apparent from FIG. 12, a polygonal lid is defined using printed marks on the film or foil 9, the recess 10a corresponding to the depression 7a. On the opposite side, there is a gripping lug 11a that engages the recess 10a of the adjacent lid for purposes of saving material. If the lids 3c are punched out, unwanted scrap can be expected only in the edge region of the film or foil 9.

In summary, it can be stated that the package according to the invention, on the one hand, saves film or foil material for the container lid and, on the other hand, achieves an especially imaginative shape of the lid or, adapted thereto, the container. Although deliberate differentiation from competitive products is achieved using this packaging design, it is still at the same time user-friendly and makes it possible, due to closure by means of a sealing seam, for the filled package contents, such as foods, to be protected against contaminants, such as air, moisture or bacteria.

1. Package consisting of a container and a lid, the lid being attached to the container edge by way of a sealing layer, characterized in that the container wall at least in the region of the container edge has a depression formed toward the container interior.

2. Package according to claim 1, wherein the depression has the shape of a circular segment.

3. Package according to claim 2, wherein the container edge shows a scored line according to the shape of the circular segment.

4. Package according to claim 1, wherein the depression is V-shaped.

5. Package according to claim 1, wherein the lid is round.

6. Package according to claim 1, wherein the lid has a recess according to the depression and in addition has a gripping lug.

7. Package according to claim 1, wherein the lid is hexagonal.

8. Package according to claim 1, wherein the lid is polygonal and has a gripping lug.

9. Package according to claim 7, wherein the container is hexagonal.

10. Package according to claim 1, wherein the lid has a layer of printing lacquer.

11. Container according to claim 1, wherein the lid is embossed.

12. Package according to claim 1, wherein the sealing layer is superficially rough.

13. Package according to claim 12, wherein there is a printed subject with a rough surface in the form of a sealing layer.

14. Package according to claim 1, wherein the sealing layer has grainy additives.

15. Method for producing a lid for the package according to claim 1, wherein the lid form is applied to a film or foil material using printed marks, and it is then punched out according to the printed marks.

16. Method for producing a lid for the package according to claim 1, wherein the parent material for the container is heated and worked using thermoforming by means of die and matrix tools that are such that a depression is produced in at least the edge region of the container.

17. Package according to claim 8, wherein the container is hexagonal.
